(19) United States
(12) Patent Application Publication
(10) Pub. No.: US 2005/0280705 A1
(43) Pub. Date: Dec. 22, 2005

(54) Portable receiver device

(75) Inventors: Tazwell Anderson JR., Atlanta, GA (US); Geoffrey L. Anderson, Atlanta, GA (US); Mark A. Wood, Decatur, GA (US)

Correspondence Address: Dean D. Small;Armstrong Teasdale LLP, Ste. 2600, One Metropolitan Square, St. Louis, MO, 63102, US

(73) Assignee: Immersion Entertainment, Atlanta, GA (US)

(21) Appl. No.: 11/128,527

(22) Filed: May 13, 2005

Related U.S. Application Data
(60) Provisional application No. 60/572,702, filed on May 20, 2004.

(51) Int. Cl. H04N 7/18

(52) U.S. Cl. 348/143; 348/838; 380/210

(57) ABSTRACT

A portable receiver device that comprises of a receiver component for receiving audio and video signals from a remote source and a viewing component for viewing local content and a display for displaying at least one of (i) video content defined by the video signals and (ii) local content from the viewing component, and wherein at least one of the received video signals and local content are encrypted.

### RELATED APPLICATION

This application claims priority to and the benefit of the filing date of U.S. Provisional Application No. 60/572,702 filed on May 20, 2004 the complete subject matter of which is hereby incorporated by reference in its entirety.

### BACKGROUND OF THE INVENTION

The availability of timely information is often critical to maintaining successful operations. For example, throughout military history, the outcomes of battles have been decided (i.e., won and lost) in a large part based on the accuracy and timeliness of the intelligence (e.g., information) related to the disposition, strength and intentions of the opposing force. In an attempt to gain a military advantage, armies have attempted to utilize the best available technology to ensure that commanders had the latest and most up to date intelligence in order to develop battlefield strategies that would then be communicated to frontline units in a timely manner.

As a specific example, during the War Between the States, cavalry units provided commanding officers with the location and movements of the opposing side. The lack of such information by Confederate cavalry at Gettysburg was a key factor in the ultimate outcome of the battle. Also, for the first time, observation balloons were used in an attempt to increase the accuracy of artillery fire and to locate enemy positions in real-time on the battlefield.

As another specific example, during the first World War, aircraft observation was used to provide commanders in the rear with intelligence related to enemy positions, movements and lines of supply. The use of telephone communications then enabled battle orders to be communicated to the front to ensure that attacks were coordinated across long fronts, and were based on the latest information.

As still another specific example, in World War II, battlefield intelligence was gained through the monitoring of enemy radio transmissions and the breaking of complex codes. Unfortunately, the value of much of the information collected was reduced because the timely dissemination of vital intelligence was often delayed due to the time required to analyze and decode signals, or due to the fear of compromising the fact that codes had been broken.

As yet another specific example, during the cold war, high altitude reconnaissance aircraft and satellite observation were used, allowing commanders and planners to determine the disposition of opposing forces. However, because both sides during the cold war had similar technology and information related to the times that they were being observed, precautions could be taken to camouflage critical equipment or locations. More importantly, the time required to recover, process and disseminate, for example, the film from first generation high altitude platforms made them useful for strategic purposes only, and not available to effect tactical decisions in a real time manner.

In the 1980's and 1990's advances in satellite technology reduced the time required to disseminate high altitude information. Newer systems used digital imaging instead of film processing, such that satellite imagery could be transmitted to earth stations for image processing. More importantly, satellites could be repositioned such that trouble spots (e.g., areas from where receiving information is difficult) around the globe could be monitored to enable planners to formulate tactical strategies that were then communicated to combat commands. However, these systems, although providing high resolution, high altitude platforms, were still not an effective tool for providing real time intelligence to, for example, a company, platoon, squad and special operations units.

Beginning with the first Gulf War, as a result of advances in micro electronics technology, CCD digital imaging, and GPS satellite navigation, small remotely piloted unmanned aerial vehicles (UAVs) were deployed to provide rear echelon commanders with live video imaging of the battlefield so that they could update and modify battle plans and re-deploy units as the tactical situation dictated. The ability to provide on the move flexibility in unit disposition was one of the key components of the maneuver warfare strategy that won the war.

Currently wartime operations are performed in remote and rugged terrain, for example, of Afghanistan and Iraq, and wherein UAVs are enabling not only commanders away from the frontline, but also front line units and behind the lines special forces teams to monitor live video from the UAVs using laptop computers. This ability for real time viewing of opposing forces has changed battlefield operations. Frontline commanders can now obtain up to the minute updates of the progress of a battle and observe the effectiveness of artillery or close air support, redirect components under their command, and monitor the movements of the opposing forces. With the use of improved optics and electronics, video signals received from artillery and mortar shells soon may be used and which can be directed, for example, into live skirmish areas, thus allowing viewing of the action in real time.

Presently, in battle situations, units are required to carry into battle ruggedized laptop computers that are equipped with video receiver cards that enable the computers to receive and decode the encrypted video transmissions from a variety of airborne platforms. Although dependable and effective, laptop computers are not conducive to rapid movement on the battlefield, have significant power requirements, are not “instant on”, require a boot up period and often are heavy and cumbersome. In addition, due to the cost of the laptops, only a limited number of laptops usually can be provided to company or platoon sized units. Thus, the information is not broadly disseminated and the devices on which the information is received are often not adequate for the needs in battle time.

The availability of timely information is also important in non-combat settings. For example, when performing local surveillance or security monitoring, for example, at docks, buildings having sensitive operations, etc., it is important to receive information (e.g., video feeds) in a timely manner to ensure proper operations (e.g., protection of a building having sensitive operations from unauthorized access).

Thus, the ability to obtain and disseminate information in a timely and efficient manner is often critical to maintaining successful operations.

### BRIEF DESCRIPTION OF THE INVENTION

Various embodiments of the invention provide a portable handheld device configured to receive video and/or audio signals. Different received signals may be selected by a user for display on the portable handheld device.

### BRIEF DESCRIPTION OF THE DRAWINGS

FIG. 1 is a block diagram of a portable handheld device in accordance with an exemplary embodiment of the invention.

### DETAILED DESCRIPTION OF THE INVENTION

In general, various embodiments of the invention provide a device configured as a portable, ruggedized, handheld video receiver/binocular that can be used, for example, to view encrypted battlefield video transmitted from, for example, a variety of remotely piloted aerial vehicles and/or RECON artillery/mortar rounds that are either currently being used, or to be developed in the future. The video systems have been designed to enable commanders in the rear and small platoons or company sized units at the front to monitor live video of the local battlefield or other targets of interest. Various embodiments of the device enable this information to be made available to, for example, squads and individuals, thus, increasing the likelihood of the widest dissemination of video intelligence and other command video and digital signals in a timely and secure manner. The video signals may be received from any source in the air, for example, any projectile, plane (manned or unmanned), drone, artillery shell, etc. capable of transmitting video signals. Further, audio signals also may be transmitted and received.

Additionally, the various embodiments of the invention are not limited to receiving video content from military sources. For example, the various embodiments may be configured to receive video and/or audio signals relating generally to any security or surveillance applications. Such applications include, for example, video and/or audio signals at docks, buildings having sensitive operations, homes (e.g., camera in baby's room), etc.

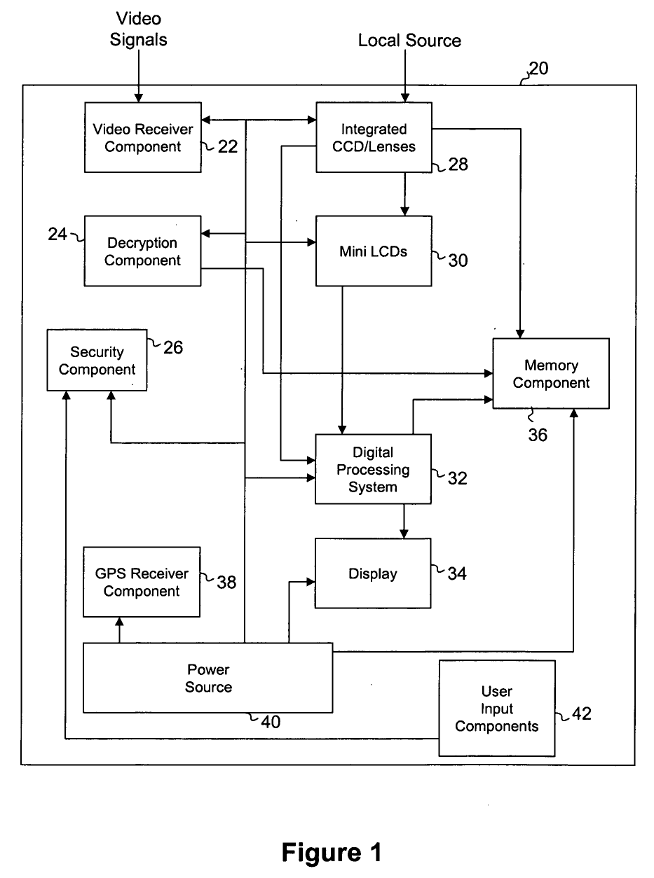

Specifically, and as shown in FIG. 1, a portable receiver device 20 is provided for displaying real-time or live audio and video content. The portable receiver device 20 generally includes a viewer that allows for viewing of standard analog or digital video. The a portable receiver device 20 is configured to allow a user to select between different video and/or audio signals, for example, on a plurality of selectable channels, which may include live or pre-recorded audio and video. In addition, by combining a CCD and lens on the portable receiver device 20, live digital images can be viewed on internal LCDs, thus, allowing the user to have a digital binocular for viewing the event. Further, one or more memory components are provided to allow a user to select, for example, single images or video clips to be stored for later viewing.

In various embodiments, the portable receiver device 20 is configured having a ruggedized casing or housing for use, for example, in a harsh environment typical of combat. Thus, in one embodiment, a Battlefield Video Receiver (BVR) that could be provided to each soldier or squad in place of normal optical binoculars is provided. The BVR would allow the soldier to receive transmitted video from UAVs, RECON mortar rounds equipped with cameras, or any other transmitted video signal which commanders needed to relay to the front line (e.g., signals from an encrypted battlefield video system). Additionally, audio content also may be received.

The portable receiver device 20 generally provides the following capabilities and/or functionality:
Video Receiver component to receive transmitted video signals
Decryption component to decrypt encrypted signals
Embedded security component to prevent compromise of data
Dual CCD/Lens components to enable a range finder capable digital binocular mode
Dual mini LCDs for the display of received video and/or real time binocular views
Digital video processing capability
Memory for storing images from received video or real time binocular views
GPS/Range finding capability
Rechargeable battery power for extended operation
Ruggedized enclosure to ensure operation in a combat environment

The various components of various embodiments of the portable receiver device 20 will now be described.

In various embodiments, the portable receiver device 20 includes an embedded antenna and UHF or Microwave video receiver component 22 that is compatible with the transmission frequencies used in current and future developed UAVs, Recon Artillery/Mortar rounds, and other video surveillance systems. The video receiver component 22 enables a user to select and tune in predetermined or predefined channels/frequencies (e.g., prebriefed channels/frequencies). In general, the video receiver component 22 is configured to receive, for example, video signals from any battlefield video system, surveillance system security system, etc. The video receiver component 22 is configured to receive content from any remote source (e.g., aerial surveillance video source).

In various embodiments, the portable receiver device 20 also includes a decryption component 24 to decrypt any received signals that are encrypted (e.g., encrypted signals from battlefield video surveillance systems) to allow the encrypted signals to be viewed. The encryption system providing the encrypted signals may be preprogrammed for security based on the insertion of a specific daily code, or may be implemented via the insertion of a small card or memory stick type device, with the decryption component 24 configured to decrypt the code.

In various embodiments, the portable receiver device 20 also includes a security component 26 that is activated or unlocked or enabled to allow access to the portable receiver device 20 (e.g., to information stored therein or to turn on the portable receiver device 20). The activation may be provided, for example, by the insertion of a multi-digit code or through use of a fingerprint touch pad. It should be noted that any suitable computer based security systems may be implemented that allows disabling the portable receiver device 20 if unauthorized access is attempted (e.g., unauthorized person tries to operate) or requires a code or other authorization to access the portable receiver device 20.

In various embodiments, the portable receiver device 20 also provides a real-time digital binocular function with one or more integrated CCD/Lenses 28 that provide a real time video image (e.g., live or local content, images or events) to internal mini LCDs 30 for use in viewing by a user. Thus, the portable receiver device 20 is configured to receive information (e.g., viewing events) from local sources (e.g., live events viewed using the portable receiver device 20). The CCD/Lens 28 enable a digital zoom feature for the area being viewed. In addition, a digital focus capability may be provided to provide a range finding mode of operation. This range finding mode of operation includes display of range to target on the viewer LCD, and may be combined, for example, with a GPS receiver output to calculate positional information (e.g., latitude or longitude and/or grid coordinates) of a target being viewed.

In various embodiments, the portable receiver device 20 includes a pair of mini (e.g., 1.1-1.8 inch diagonal) LCDs 30. The mini LCDs 30 may be any suitable mini LCD such as are implemented in the view finders of digital cameras and camcorders. The mini LCDs 30 are mounted in an optical “box” that shields the mini LCDs 30 from outside light sources and incorporate the necessary magnifying optics, that may be varied based on the application, to enable the user to view the displayed image. The use of mini LCDs 30 enables transmitted video, real time binocular images, and digital data to be displayed for viewing by the operator. It should be noted that in addition to raw video, encrypted messages may be included for display on the portable receiver device 20.

In various embodiments, the portable receiver device 20 also includes a video processing system 32 (e.g., digital processing system) that receives the decrypted video signal received by the portable receiver device 20 and processes the signal for display on a display 34. The video signal may be received from, for example, normal video cameras, low light level cameras and/or forward looking infrared (FLIR) sensors depending on the time of day and type of operations being conducted or particular application. Any embedded communications that are included with the video signal may be displayed for the user to view. In addition to the transmitted video, the video processing system 32 also processes for display the output of the CCD/Lens 28 to provide the user, for example, with a real time zoom binocular function.

In various embodiments, the portable receiver device 20 also includes a memory component 36 that includes memory or storage to store transmitted video, or observed real time video such that the video may be reviewed at a later time. In addition, any stored real time images/video that are observed by a user and stored, then may be transmitted to other units/command and control organizations using an interface such as, for example, a laptop computer or similar device that incorporates a transmission capability. In another embodiment, a transmission component may be provided as part of the portable receiver device 20.

In various embodiments, the portable receiver device 20 includes a GPS receiver component 38 enabling a user, for example, to determine or verify their position while they are maneuvering and while they are observing a target. In addition, by combining the range finding capability of the portable receiver device 20, a position solution for an observed target can be determined in either latitude/longitude or in grid coordinates. This positional information can be used to verify a known target or to determine the position of newly observed targets such that targeting information can be developed and communicated, for example, to command authorities.

In various embodiments, the portable receiver device 20 also includes a power source 40, such as, for example, a rechargeable lithium ion, lithium polymer or fuel cell power units. In one embodiment, the power source 40 is encased behind an access door enabling a user to change, for example, batteries. A battery charge port also may be provided to enable recharging from, for example, standard ac and dc power sources. If a fuel cell is used, a refill port for adding additional fuel is included.

In various embodiments, the portable receiver device 20 is enclosed or encased in a housing or case, such as, for example, a cast magnesium case to ensure survivability in a combat environment. The housing also provides an EMI/RFI shield for the electronic components to minimize static and interference. In addition, the housing also provides heat sinking for the processing components to, for example, ensure operating temperatures do not exceed specified limits for the electronics. The housing, in various embodiments, includes interface components, for example, for installing memory, batteries, recharging, etc. In addition, the housing includes user input and operation components 42 (e.g., actuation buttons, access doors, neck strap, etc.) for use when using the portable receiver device 20.

In operation, various embodiments of the portable receiver device 20 allow use in combat, as well as non-combat applications. For example, the portable receiver device 20 may receive video signals and display corresponding images acquired by UAVs that provide live surveillance video of a battlefield. This allows, for example, command and control authorities to view real-time battlefield conditions, or identify high value targets to enable the use of forces with more precision. This not only increases the probability of success, but ensures the maximum and efficient utilization of ground forces and other assets.

As an example, in a battle application the portable receiver device 20 provides real-time video and command and control messaging to be provided to squads and individuals to provide wide dissemination of real-time information. In addition, specialized information being transmitted from command and control authorities at the rear can be received in video or digital format using the portable receiver device 20. For example, a medic with a portable receiver device 20 may select a separate channel to receive a video link from a MASH unit that could provide key information regarding the treatment of a casualty. Coordination of smaller units using the portable receiver device 20 also enables improved control of the battlefield by commanders. Further, because the portable receiver device 20 has the capability to record what is viewed when operating in the binocular mode, and then interface with a transmitter, commanders now have the ability to view the battlefield or targets of opportunity being monitored from the view point of multiple locations on the battlefield.

It should be noted that the portable receiver device 20 may be modified or configured as desired or needed (e.g., based on application or communication or viewing requirements). Thus, the portable receiver device 20 may be configured to display images or output sounds based on signals transmitted from a plurality of different sources. For example, various components of the portable receiver device 20 may be configured as described in co-pending U.S. application entitled “Electronic Handheld Audio/Video Receiver and Listening/Viewing Device” filed on Apr. 18, 2001 and having Ser. No. 09/837,128, the entire disclosure of which is hereby incorporated by reference herein; the devices described in co-pending U.S. application “Audio/Video System and Method Utilizing a Head Mounted Apparatus with Noise Attenuation” filed on Aug. 31, 1999 and having Ser. No. 09/386,613, the entire disclosure of which is hereby incorporated by reference herein; and the devices described in co-pending U.S. application entitled “Electronic Handheld Audio/Video Receiver and Listening/Viewing Device” filed on Jul. 30, 2003 and having Ser. No. 10/630,069, the entire disclosure of which is hereby incorporated by reference herein.

While the invention has been described in terms of various specific embodiments, those skilled in the art will recognize that the invention can be practiced with modification within the spirit and scope of the claims.

1. A portable receiver device comprising:
a receiver component for receiving audio and video signals from a remote source;
a viewing component for viewing local content; and
a display for displaying at least one of (i) video content defined by the video signals and (ii) local content from the viewing component, and wherein at least one of the received video signals and local content are encrypted.

2. A portable receiver device in accordance with claim 1 further comprising a memory component for storing at least one of the video content and local content.

3. A portable receiver device in accordance with claim 1 further comprising at least one CCD/Lens configured to provide zoom binocular viewing having range finding capabilities.

4. A portable receiver device in accordance with claim 1 further comprising a GPS receiver component configured to provide positioning information in connection with at least one of the video content and local content for determination of a target position.

5. A portable receiver device in accordance with claim 1 wherein the encrypted content comprises encrypted content received from an encrypted battlefield video system.

6. A portable receiver device in accordance with claim 1 wherein the receiver component receives video signals from an aerial surveillance video source.

7. A portable receiver device in accordance with claim 1 further comprising an encryption system providing preprogrammed encryption to the video signal for security based on a specific code.

8. A portable receiver device in accordance with claim 1 further comprising a description component to decrypt the received video signals.

9. A portable receiver device in accordance with claim 1 further comprising a security component that is locked and unlocked to allow selective access to the portable device.

10. A portable receiver device in accordance with claim 1 further comprising a security component that is locked and unlocked to allow selective access to the portable device, the security component utilizing one of the multi-digit code and a fingerprint touch pad.

11. A portable receiver device comprising:
a receiver component for receiving audio and video signals from a remote source;
a viewing component for viewing local content,
a display for displaying at least one of (i) video content defined by the video signals and (ii) local content from the viewing component, and wherein at least one of the received video signals and local content are encrypted; and
a GPS receiver component configured to provide positioning information in connection with at least one of the video content and local content for determination of a target position.

12. A portable receiver device in accordance with claim 11 further comprising at least one CCD/Lens configured to provide zoom binocular viewing having range finding capabilities.

13. A portable receiver device in accordance with claim 11 further comprising an encryption system providing preprogrammed encryption to the video signal for security based on a specific code.

14. A portable receiver device in accordance with claim 11 further comprising a description component to decrypt the received video signals.

15. A portable receiver device in accordance with claim 11 further comprising a security component that is locked and unlocked to allow selective access to the portable device.

16. A portable receiver device comprising:
a receiver component for receiving audio and video signals from a remote source;
a viewing component for viewing local content,
a display for displaying at least one of (i) video content defined by the video signals and (ii) local content from the viewing component, and wherein at least one of the received video signals and local content are encrypted; and
a security component that is locked and unlocked to allow selective access to the portable device.

17. A portable receiver device in accordance with claim 16 wherein the receiver component receives video signals from an aerial surveillance video source.

18. A portable receiver device in accordance with claim 16 further comprising an encryption system providing preprogrammed encryption to the video signal for security based on a specific code.

19. A portable receiver device in accordance with claim 16 further comprising a description component to decrypt the received video signals.

20. A portable receiver device in accordance with claim 16 further comprising a security component that is locked and unlocked to allow selective access to the portable device, the security component utilizing one of the multi-digit code and a fingerprint touch pad.
